(19) United States
(12) Patent Application Publication
(10) Pub. No.: US 2009/0233649 A1
(43) Pub. Date: Sep. 17, 2009

(54) THREE-DIMENSIONAL USER INTERFACE AND A METHOD FOR CONTROLLING IT

(75) Inventor: David Per BURSTROM, Lund (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 12/046,484

(22) Filed: Mar. 12, 2008

(51) Int. Cl. H04M 1/00; G06T 15/00

(52) U.S. Cl. 455/566; 345/419

(57) ABSTRACT

The present invention relates to a portable communication device comprising a display unit capable of showing 3D-modeled images and an image control unit for controlling and providing said images. Furthermore, a detector element is arranged on the portable communication device for collecting data about ambient light conditions. The image control unit is arranged to model the three-dimensional image based on the collected data in such a way that it appears natural in said ambient light conditions.

### TECHNICAL FIELD OF THE INVENTION

The present invention relates to the field of portable communication devices and more particularly to a portable communication device comprising a display unit for displaying an image in three dimensions (3D). Furthermore, the present invention relates to a method for controlling the appearance of a three-dimensional image in the display unit of the portable communication device.

### DESCRIPTION OF RELATED ART

Portable communication devices like cellular telephones may provide a MMI (Man-Machine-Interface), for instance a conventional TFT display, a stereoscopic display, or any other type of displaying means. Today these displays usually show a flat image, but it is more and more common to model the output to the display in such a way that a user experiences the image as a 3D-image.

In a few years 3D-modeled images will probably be common in cellular telephones such that a user can see or experience images in three dimensions, which will then probably add features to the telephone, in particular as regards improved reality of images.

However, today there are still problems with how a user experiences the appearance of a 3D-image. It might be easy to model 3D-images that look natural in an environment with constant ambient light conditions. However, in reality this is seldom the case. Therefore, today's 3D-images do not appear natural when the light conditions vary in for instance a room. The user does often not have a clue why the 3D-image looks a bit strange, but feels that something is wrong. The reason for this is that the shadows of the physical keys of the telephone and the 3D-modeled images do not always coincide. This makes the 3D-images appear unnatural.

### SUMMARY OF THE INVENTION

The present invention is directed towards solving the problem with 3D-images that appear unnatural.

One object of the present invention is to provide a portable communication device having improved features for the MMI compared to today's possibilities.

According to a first aspect of the present invention, this object is achieved by a portable communication device comprising:

a display unit capable of showing 3D-modeled images;

an image control unit (22) for controlling and providing said images;

a detector element (18) arranged on the portable communication device (2) for collecting data about the ambient light conditions, and wherein

said image control unit (22) is arranged to model the three-dimensional image in such a way that it appears natural in said ambient light conditions.

A second aspect of the present invention is directed towards a portable communication device including the features of the first aspect, wherein said detector element is a camera having a wide-angle lens.

A third aspect of the present invention is directed towards a portable communication device including the features of the second aspect, wherein said detector element is a low-resolution camera.

A fourth aspect of the present invention is directed towards a portable communication device including the features of anyone of the previous aspects, wherein said detector element is arranged in a bowl shape in the same plane as said display unit.

A fifth aspect of the present invention is directed towards a portable communication device including the features of anyone of the previous aspects, wherein said detector element 18 has a wide-angle range of at least 90°, preferably at least 160°.

A sixth aspect of the present invention is directed towards a portable communication device including the features of anyone of the previous aspects, wherein said detector device is arranged to detect color variation.

A seventh aspect of the present invention is directed towards a portable communication device including the features anyone of the previous aspects, wherein said detector element is connected to an image processing unit, arranged to create a map of the ambient light conditions.

An eight aspect of the present invention is directed towards a portable communication device including the features of the seventh aspect, wherein said image processing unit is arranged and connected to the image control unit for providing the image control unit with the map of ambient light conditions.

A ninth aspect of the present invention is directed towards a portable communication device including the features of anyone of the previous aspects, further comprising a backlight controller, which is arranged and connected to the image processing unit in such a way that the backlight controller is able to control the backlight in response to the map of the ambient light conditions.

A tenth aspect of the present invention is directed towards a method for controlling the appearance of a three-dimensional image in a display unit of a portable communication device, comprising the steps of:

collecting data about ambient light conditions in a wide-angle range of at least 90° in relation to the plane of the display unit;

processing the collected data into a map of ambient light conditions;

modeling the three-dimensional image in response to the map of ambient light;

displaying the modeled three-dimensional image on the display unit.

A eleventh aspect of the present invention is directed towards a method for controlling the appearance of a three-dimensional image in a display unit of a portable communication device including the features of the tenth aspect, further comprising the step of:

controlling a backlight controller (24) in response to the map of ambient light.

The invention has many advantages. For instance, is it now possible to model 3D-images that appear natural and there will no longer be any differences in appearance between the 3D-modeled images and the physical keys of the telephone. Furthermore, the output of the detector element may not only be used to control 3D-images but may also be used by the backlight controller to enhance battery saving.

It should be emphasized that the term “comprises/comprising” when used in this specification is taken to specify the presence of stated features, integers, steps or components, but does not preclude the presence or addition of one or more other features, integers, steps, components or groups thereof.

### BRIEF DESCRIPTION OF THE DRAWINGS

The present invention will now be described in more detail in relation to the enclosed drawings, in which:

FIG. 1 schematically shows a front view of a portable communication device in the form a cellular telephone, having a 3D-display, according to an embodiment of the invention,

FIG. 2 schematically shows a simplified block diagram of relevant parts of the cellular telephone illustrated in FIG. 1,

FIG. 3 shows two views of the front side of a cellular telephone, with different ambient light conditions.

### DETAILED DESCRIPTION OF EMBODIMENTS

A portable communication device according to the present invention will now be described in relation to a cellular telephone, which is a preferred variation of the invention. However, the portable communication device can also be another type of device, like a cordless telephone, a communication module, a PDA or a lap top computer or any other type of portable device communicating with radio waves.

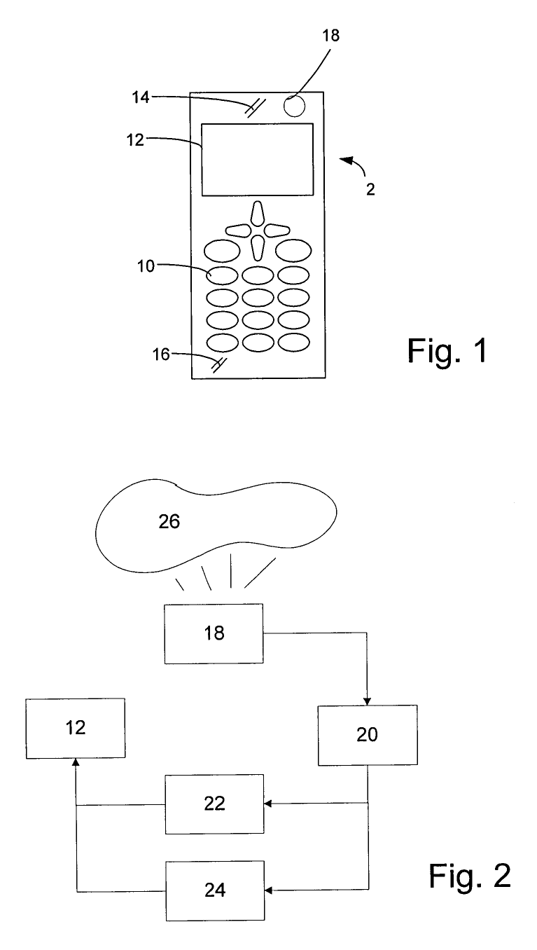

FIG. 1 schematically shows a front view of a cellular telephone 2 according to an embodiment of the present invention. The telephone 2 includes input/output devices such a number of keys 10 on a keypad provided below a display 12, a loud speaker 14 and a microphone 16. These are all common features for a portable communication device and are well known by a person skilled in the art and are therefore not described in detail.

However, the display 12 is a display having the capability to output 3D-modeled images. The display can be any suitable display including enhanced stereoscopic displays having 3D functionality providing a sense of depth in the image shown or also a conventional TFT display. Thus, also a display including polarization glasses or the like to provide a 3D functionality is possible without departing from the scope of the invention. Since such technology and other 3D image conversion techniques are well known for a person skilled in the art, a more detailed description thereof will not be given herein. It should be understood that the present invention is not dependent on the type of display used as long as a3D-modeled image can be shown thereon.

The telephone 2 depicted in FIG. 1, is furthermore provided with a detector element 18. The detector element 18 is provided to collect data about the ambient light conditions surrounding the telephone 2. The detector element 18 is preferably a light sensor, capable of mapping the surrounding light. In a preferred embodiment of the present invention the light senor 18 is a simple low-resolution camera having a wide-angle lens. The angle should be close to 180° in relation to the plane of the display 12, both in a vertical and horizontal direction. In a preferred embodiment of the present invention, the wide-angle is preferably at least 160°. However, it is also possible to use an angle of at least 90°, but of cause this will affect the quality of the 3D-modeled images. In context of this specification it should be understood that by low-resolution is meant a resolution of 128×128 pixels or less. However, it is within the scope of the invention to use any camera or light sensor that is capable of collecting data of the ambient light. The reason why a low-resolution camera is preferred is that it is cost efficient, without markedly effecting the quality of the 3D-modeled image.

Physically, the light senor 18 is arranged on the front of the telephone 2 in the same plane as the display 12. In a preferred embodiment, the light sensor 18 is arranged in a bowl shape, in a similar way that a human eye functions. However, it is not important how the light sensor is arranged or looks as long as it is able to collect data of the ambient light in a range of at least 90°, preferably at least 160° in relation to the plane of the display 12. Thus, it is important that the senor can collect data within a wide range of light intensities. In a preferred embodiment the light sensor 18 may also be able to detect color variations.

Now is referred to FIG. 2, which schematically shows a simplified block diagram of the interior parts of the telephone illustrated in FIG. 1 that are relevant to the present invention according to the one embodiment. Thus, conventional parts such as signal processing parts and the like, that are not directly related to the invention have been omitted in the drawings for a better understanding of the invention, since these parts and the function thereof are considered to be well-known for a person skilled in the art of portable communication devices such as cellular telephones 2.

In this embodiment, the telephone 2 includes a display unit 12 for displaying a 3D-modeled image. The display unit 12 is typically a conventional TFT display, a stereoscopic display or the like, which are known per se.

Furthermore, the telephone includes an image processing unit 20 connected to the detector element 18 and arranged to create a map of the ambient light conditions 26. Thus, the output of the detector element 18 is fed to the image processing unit 20. When, the output signal from the detector element 18 is received at the image processing unit 20 it is processed and analyzed to make a map of the ambient light conditions of the telephone 2. It should be understood that the meaning of the word map in the context of the present invention is to be interpreted in a broad sense and includes any representation that identifies the ambient light conditions. Thus, the map identifies all major light sources in the surroundings of the telephone 2. In a preferred embodiment of the present invention, the map is also capable of identifying the different colors of the light sources. In another preferred embodiment of the present invention, in which a low-resolution camera is used as the detector element 18, the image itself may be used as a map of the ambient light conditions.

FIG. 2 furthermore shows an image control unit 22, the input of which is connected to the output of the image processing unit 20. The image control unit 22 3D-models the output to the display 12, i.e. features such as buttons, scroll bars, knobs and similar. When modeling the 3D-images the image control unit 22 uses the map of the ambient light conditions in order to illuminate the features in such a way that their appearance looks like the real light illuminates them. Thus, the shadows from the keys 10 will coincide with the user experienced shadows of the 3D-modeled features.

Since, the detector element 18 continuously will update the ambient light data when the display is in an active mode, the 3D-modeled images will shift appearance in accordance to how the ambient light varies, when a user rotates the telephone 2. If as mentioned above, also the picture itself is used when modeling the 3D-image, it may be used for environment mapping and thus it is possible to model 3D-images in which the environment is reflected.

FIG. 2 furthermore comprises a backlight controller 24, which is known per se. In a preferred embodiment of the present invention the output from the detector element 18 and thus the image processing unit 20 is not only used for modeling 3D images, but is also used as input data to the backlight controller 24. By using this input data it will be possible to control the backlight in a better manner and battery would be saved.

The image processing unit 20 typically comprises a processor executing a program to create a map, and a memory referenced by the processor. The processor may be a special dedicated processor, or a processor such as a microprocessor that is used for other purposes in the telephone. Also the image control unit 22 comprises a processor for executing a program for modeling a 3D image and a memory. Also in this case it could be a dedicated processor or a processor used for other purposes in the telephone.

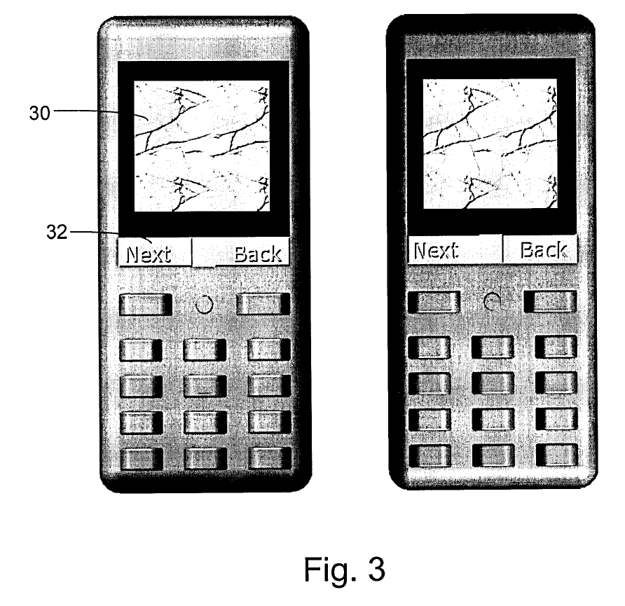

FIG. 3 shows how two telephones having different ambient light conditions would look using the 3D modeling according to the present invention. The displays of the telephones show a bump mapped stone texture 30 and two soft keys 32 with embossed labels. For the telephone on the left hand side of FIG. 3 the ambient light comes from the upper left and thus the shadow of the light can be seen at the bottom and to the right of the soft keys. For the telephone on the right hand side of FIG. 3 the ambient light is instead coming form the lower right. Accordingly, the shadows of the soft keys of the right telephone can be seen at the top and to the left of the soft keys.

The portable communication device according to the present invention can be varied in a number of ways apart from what has been disclosed above. For example, instead of using a special detector element it would be possible to use a camera already provided in the front of telephone, such as a camera for performing video telephone conversations. It, is however import to remember that such a camera needs to have a wide-angle lens of at least in the range of 90°. It shall also be understood that even if the present invention has been described with preferred embodiments having certain features it is obvious to a person skilled in the art that individual features in one embodiment could be combined with other embodiments or other individual features in other embodiments.

1. A portable communication device comprising:
a display unit capable of showing 3D-modeled images;
an image control unit for controlling and providing said images;
wherein a detector element is arranged on the portable communication device for collecting data about ambient light conditions, and
said image control unit is arranged to model the three-dimensional image in such a way that it appears natural in said ambient light conditions.

2. A portable communication device according to claim 1, wherein said detector element is a camera having a wide-angle lens.

3. A portable communication device according to claim 2, wherein said detector element is a low-resolution camera.

4. A portable communication device according to claim 1, wherein said detector element is arranged in a bowl shape in the same plane as said display unit.

5. A portable communication device according to claim 1, wherein said detector element has a wide-angle range of at least 90°, preferably at least 160°.

6. A portable communication device according to claim 1, wherein said detector device is arranged to detect color variation.

7. A portable communication device according to claim 1, wherein said detector element is connected to an image processing unit, arranged to create a map of the ambient light conditions.

8. A portable communication device according to claim 7, wherein said image processing unit is arranged an connected to the image control unit for providing the image control unit with the map of ambient light conditions.

9. A portable communication device according to claim 1, further comprising a backlight controller, which is arranged and connected to the image processing unit in such a way that the backlight controller is able to control the backlight in response to the map of the ambient light conditions.

10. A method for controlling the appearance of a three-dimensional image in a display unit of a portable communication device, comprising the steps of:
collecting data about ambient light conditions in a wide-angle range of at least 90° in relation to the plane of the display unit;
processing the collected data into a map of ambient light conditions;
modeling the three-dimensional image in response to the map of ambient light; displaying the modeled three-dimensional image on the display unit.

11. A method for controlling the appearance of a three-dimensional image according to claim 10, further comprising the step of:
controlling a backlight controller in response to the map of ambient light.
